(19) United States
(12) Patent Application Publication
(10) Pub. No.: US 2023/0376753 A1
(43) Pub. Date: Nov. 23, 2023

(54) SEMANTIC-AWARE RANDOM STYLE AGGREGATION FOR SINGLE DOMAIN GENERALIZATION

(71) Applicant: QUALCOMM Incorporated, San Diego, CA (US)

(72) Inventors: Seokeon CHOI, Yongin-si (KR); Sungha CHOI, Goyang-si (KR); Seunghan YANG, Incheon (KR); Hyunsin PARK, Gwangmyeong (KR); Debasmit DAS, San Diego, CA (US); Sungrack YUN, Seongnam (KR)

(21) Appl. No.: 18/157,723

(22) Filed: Jan. 20, 2023

Related U.S. Application Data
(60) Provisional application No. 63/343,474, filed on May 18, 2022.

(51) Int. Cl. G06N 3/08

(52) U.S. Cl. CPC G06N 3/08

(57) ABSTRACT

Systems and techniques are provided for training a neural network model or machine learning model. For example, a method of augmenting training data can include augmenting, based on a randomly initialized neural network, training data to generate augmented training data and aggregating data with a plurality of styles from the augmented training data to generate aggregated training data. The method can further include applying semantic-aware style fusion to the aggregated training data to generate fused training data and adding the fused training data as fictitious samples to the training data to generate updated training data for training the neural network model or machine learning model.

### CROSS-REFERENCE TO RELATED APPLICATIONS

This application claims the benefit of U.S. Provisional Application No. 63/343,474, filed May 18, 2022, which is hereby incorporated by reference, in its entirety and for all purposes.

### FIELD

The present disclosure generally relates to machine learning systems (e.g., neural networks). For example, aspects of the present disclosure relate to systems and techniques for augmenting training data for training a neural network or a machine learning model for single domain generalization.

### BACKGROUND

Deep neural networks have achieved remarkable performance in a wide range of applications in recent years. However, this success is built on the assumption that the test data (or the target domain) should share the same distribution as the training data (i.e., source domain), and they often fail to generalize to out-of-distribution data. In practice, this domain discrepancy problem between source and target domains is frequently encountered in real-world scenarios such as medical imaging and autonomous driving.

To address this problem, one line of work focuses on domain adaptation (DA) to transfer knowledge from a source domain to a specific target domain. This approach usually takes into account the availability of labeled or unlabeled target domain data. Another line of work deals with a more realistic setting known as domain generalization (DG). Compared to domain adaptation, the task aims to learn a domain-agnostic feature representation with only data from source domains without access to target domain data. Thanks to its practicality, the task of domain generalization has been extensively studied.

In general, the paradigm of domain generalization depends on the use of multi-source domains, and research based on multi-source domains has been focused in the earlier years. The distribution shift problem can be alleviated by simply aggregating data from multiple training domains. However, this approach faces practical limitations due to data collection budgets. As a realistic alternative, a single domain generalization problem has recently received attention, which learns robust representation using only a single-source domain. The general solution of this challenging problem is to generate diverse samples to expand the coverage of the source domain through an adversarial data augmentation scheme. Some single DG efforts focus on generating effective fictitious target distributions by adversarial learning. However, most of these methods share a complex training pipeline with multiple objective functions. Furthermore, the adversarial learning scheme suffers from poor algorithm stability and requires rigorous tinkering of hyper-parameters to converge.

### BRIEF SUMMARY

In some examples, systems and techniques are described for performing semantic-aware random style aggregation for single domain generalization. According to at least one example, a method (e.g., a processor-implemented method) is provided for augmenting training data. The method includes: augmenting, via a random style generator having at least one randomly initialized layer, training data to generate augmented training data; aggregating data with a plurality of styles from the augmented training data to generate aggregated training data; applying semantic-aware style fusion to the aggregated training data to generate fused training data; and adding the fused training data as fictitious samples to the training data to generate updated training data for training a neural network.

In another example, an apparatus for augmenting training data is provided that includes at least one memory and at least one processor coupled to the at least one memory. The at least one processor is configured to: augment, via a random style generator having at least one randomly initialized layer, training data to generate augmented training data; aggregate data with a plurality of styles from the augmented training data to generate aggregated training data; apply semantic-aware style fusion to the aggregated training data to generate fused training data; and add the fused training data as fictitious samples to the training data to generate updated training data for training a neural network.

In another example, a non-transitory computer-readable medium is provided that has stored thereon instructions that, when executed by one or more processors, cause the one or more processors to: augment, via a random style generator having at least one randomly initialized layer, training data to generate augmented training data; aggregate data with a plurality of styles from the augmented training data to generate aggregated training data; apply semantic-aware style fusion to the aggregated training data to generate fused training data; and add the fused training data as fictitious samples to the training data to generate updated training data for training a neural network.

In another example, an apparatus for augmenting training data is provided. The apparatus includes: means for augmenting, via a random style generator having at least one randomly initialized layer, training data to generate augmented training data; means for aggregating data with a plurality of styles from the augmented training data to generate aggregated training data; means for applying semantic-aware style fusion to the aggregated training data to generate fused training data; and means for adding the fused training data as fictitious samples to the training data to generate updated training data for training a neural network.

In some aspects, one or more of the apparatuses described herein is, is part of, and/or includes a mobile device (e.g., a mobile telephone or other mobile device), a wearable device, an extended reality (XR) device (e.g., a virtual reality (VR) device, an augmented reality (AR) device, or a mixed reality (MR) device), connected devices, a head-mounted device (HMD) device, a wireless communication device, a camera, a personal computer, a laptop computer, a server computer, a vehicle or a computing device or component of a vehicle, another device, or a combination thereof. An electronic device (e.g., a mobile phone, etc.) is configured with hardware components that enable the electronic device to perform or execute a particular context or application. In some aspects, the apparatus includes a camera or multiple cameras for capturing one or more images or video frames of a scene including various items, such as a person, animals and/or any object(s). In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor). In some cases, machine learning models (e.g., one or more neural networks or other machine learning models) may be used to process the sensor data, such as to generate a classification related to the sensor data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 illustrates the difficulty in generalizing data from a single domain into multiple unseen target domains;

FIG. 2 illustrates different accuracies for single-source domain generalization and multi-source domain generalization;

FIG. 3 illustrates single domain data augmentation;

FIG. 4 illustrates data augmentation for a source domain and multiple target domains, in accordance with some examples;

FIG. 5 illustrates an example implementation of a system-on-a-chip (SoC), in accordance with some examples;

FIG. 6A illustrates an example of a fully connected neural network, in accordance with some examples;

FIG. 6B illustrates an example of a locally connected neural network, in accordance with some examples;

FIG. 7 illustrates various aspects of semantic-aware random style aggregation, in accordance with some examples;

FIG. 8 illustrates an example of texture modification from original data to generated data, in accordance with some examples;

FIG. 9 illustrates how contrast and brightness modification can be implemented in random style generation, in accordance with some examples;

FIG. 10 illustrates a progressive style expansion concept from original data to generated data, in accordance with some examples;

FIG. 11 is a diagram illustrating an example of semantic-aware random style aggregation and feature extraction, in accordance with some examples;

FIG. 12A illustrates qualitative results of generating data with a kernel size of 3, in accordance with some examples;

FIG. 12B illustrates qualitative results of generating data with a kernel size of 5, in accordance with some examples;

FIG. 13 is a flow diagram illustrating an example a method for performing semantic-aware random style aggregation, in accordance with some examples; and

FIG. 14 is a block diagram illustrating an example of an electronic device for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

The demand and consumption of image and video data has significantly increased in consumer and professional settings. As previously noted, devices and systems are commonly equipped with capabilities for capturing and processing image and video data. For example, a camera or a computing device including a camera (e.g., a mobile telephone or smartphone including one or more cameras) can capture a video and/or image of a scene, a person, an object, etc. The captured image and/or video can be processed and output (and/or stored) for consumption or the like. The image and/or video can be further processed for certain effects, such as compression, frame rate up-conversion, sharpening, color space conversion, image enhancement, high dynamic range (HDR), de-noising, low-light compensation, among others. The image and/or video can also be further processed for certain applications such as computer vision, extended reality (e.g., augmented reality, virtual reality, and the like), image recognition (e.g., face recognition, object recognition, scene recognition, etc.), and autonomous driving, among others.

In some examples, the image and/or video can be processed using one or more image or video artificial intelligence (AI) models, which can include, but are not limited to, AI quality enhancement and AI augmentation models. These models must in many cases have a certain level of accuracy because their use relates to safety issues with human beings. For example, AI models related to medical diagnosis or driving an automobile need to be accurate or the classification decisions can prevent a proper medical diagnosis or injure people while controlling an automobile. The accuracy of these models can be improved with more and varied training data which can be difficult to obtain.

Single domain generalization aims to train a generalizable model with only one source domain to perform well on arbitrary unseen target domains. Existing techniques focus on leveraging adversarial learning to create fictitious domains while preserving semantic information. However, most of these methods require a complex design of the training pipeline and rigorous tinkering of hyper-parameters to converge.

Systems, apparatuses, methods (also referred to as processes), and computer-readable media (collectively referred to herein as “systems and techniques”) are described herein for providing a simple approach of randomness-based data augmentation and aggregation. The randomness-based data augmentation and aggregation technique provides a strong baseline that outperforms the existing single domain generalization and data augmentation methods without complicated adversarial learning. In one illustrative aspect, the systems and techniques may aggregate progressively changing styles in a mini-batch while maintaining the semantic information. A semantic-aware random style aggregation (SARSA) framework is introduced which may involve the following three steps: random style generation, progressive style expansion, and semantic-aware style fusion. In some cases, as described in more detail herein, a random style generator may perform data augmentation based on randomly initialized neural networks. In some aspects, as described in more detail herein, progressive style expansion may be performed by passing data (e.g., data and augmented data, such as input images and augmented input images) through a random style generator repeatably to generate effective “fictitious” target distribution containing “hard” samples. Such progressive style expansion results in aggregation of various distributions into one batch. In some examples, as described in more detail herein, semantic-aware style fusion may bridge the domain gap between easy-to-classify and difficult-to-classify samples with a semantic-aware style fusion manner.

For instance, the first step (random style generation) can include generating new data from input data (e.g., generating a new image from the input image), which is referred to as data augmentation. While images are used herein as illustrative examples of data, other types of data can also be augmented, such as audio data, sensor data, speech data, biometric data, multimodal data (i.e., non-limiting examples include gesture plus biometric data or text plus graffiti input on a display screen or speech plus a gesture), any combination thereof, and/or other data. There are commonly used data augmentation methods (e.g., color jitter, gaussian blur, and geometric transformation) that are not sufficient to deal with large domain shifts between source and target domains for the single domain generalization setting. Instead of using such methods, the systems and techniques described herein introduce a random style generator including one or more randomly initialized layers. The disclosed generator can randomly transform the texture, contrast, and brightness of a given image while preserving large shapes that usually indicate the class-specific semantic information.

Although it is possible to aggregate multiple images by randomly creating styles with the proposed random style generator, the style diversity can be somewhat limited. Therefore, in the second step (progressive style expansion), the systems and techniques may include expanding the augmented images by passing the data through the random style generator repeatedly to create effective fictitious target distributions with significant differences from the source domain. Repeatedly passing augmented images through the random style generator can gradually enlarge the domain shift. However, as the number of iterations through the generator increases, the semantic information becomes more obscured. Besides, the distribution of the generated samples becomes farther away from the existing source distribution, which makes it difficult for the model to learn relevant semantic information from the images.

In the third step (semantic-aware style fusion), to bridge the domain gap between different distributions, the systems and techniques may combine two images with different styles based on their Grad-CAM (gradient-weighted class activation mapping) saliency maps. After aggregating diverse random styles generated by the proposed framework, the systems and techniques may include training a single neural network using only cross-entropy loss.

The systems and techniques described herein addresses the importance of diverse style aggregation and propose a novel approach of aggregating diverse styles in a mini-batch to solve the single domain generalization problem. A random style generator is disclosed that can randomly convert texture, contrast, and brightness. The random style generator can be an advanced version of the process of generating random convolutions, which makes it possible to aggregate various styles into a mini-batch by simply expanding the styles. It is difficult for the model to learn the relevant semantic information from fictitious images with significant differences from the source domain. To alleviate the adverse effect of enlarging domain shift, this disclosure introduces a semantic-aware style fusion method based on Grad-CAM saliency maps. The proposed semantic-aware random style aggregation (SARSA) framework is simple to implement and independent of designing a complex training pipeline. Moreover, the disclosed method significantly surpasses the state-of-the-art methods related to single domain generalization.

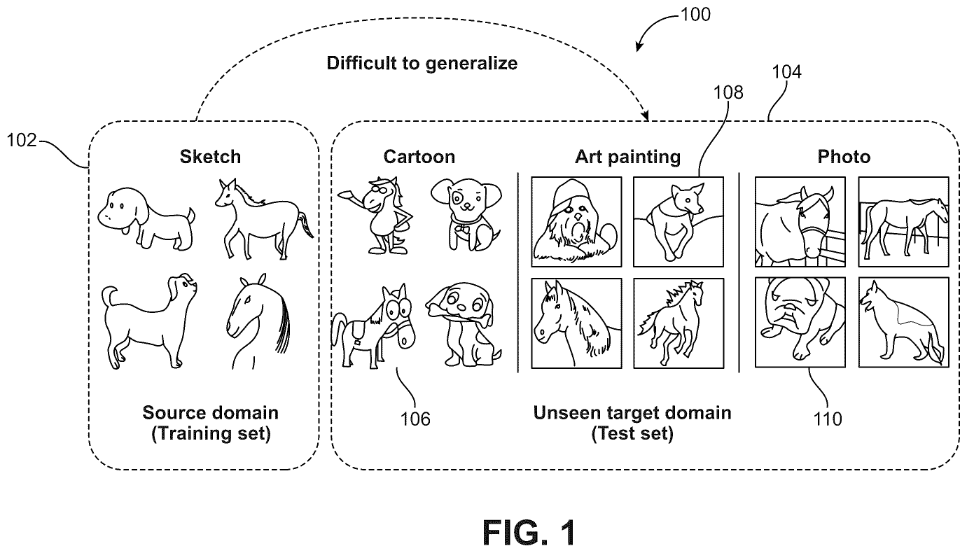

Training machine learning models or deep neural networks can be challenging, complex and expensive. One challenge in training machine learning models relates to domain discrepancy. FIG. 1 is a diagram illustrating the challenge between different sets of data 100. A training domain or training set can include, for example, sketches 102 of animals in which the machine learning model can be trained to recognize a sketch of a dog or a horse respectively as a dog or a horse. However, training the model on the sketches 102 can be difficult to generalize for other types of input data 104. For example, the input data 104 can include cartoons 106 of animals, artist paintings 108 of animals, or photos 110 of animals. These are unseen target domain or a test set of data that is difficult to generalize. A machine learning model trained on sketches may not accurately classify input from unseen target domains.

Domain discrepancy can cause safety issues. For example, when applied to medical imaging or autonomous driving, safety can be jeopardized. One solution to address this potential safety issue is domain adaptation in which the machine learning model is trained on additional domains or target data directly. However, where the unseen target data cannot be accessed, domain generalization efforts have been tried. A domain generalization task involves training a machine learning model to perform well on unseen target domain data with a different data distribution from the source domain.

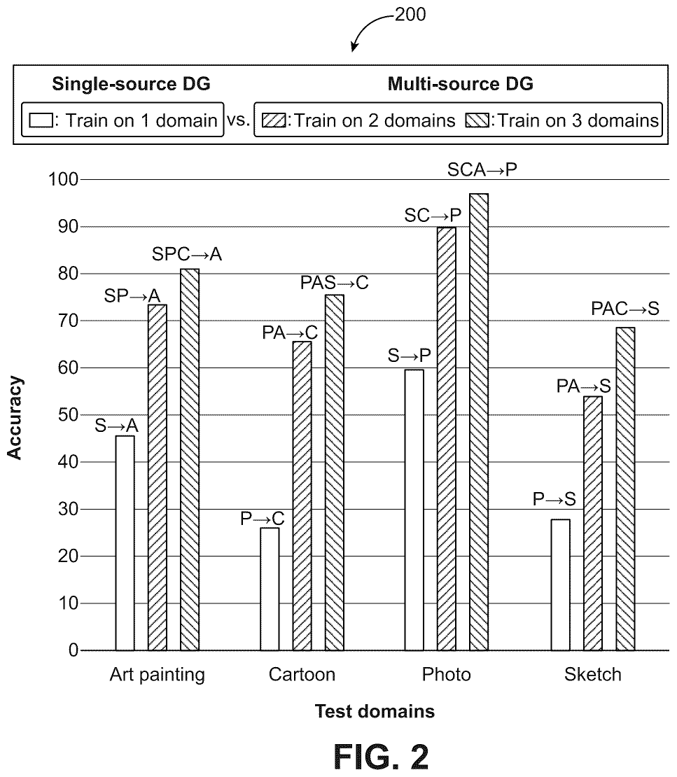

FIG. 2 illustrates a graph 200 that shows data from various test domains (e.g., art painting (A), cartoons (C), photos (P), and sketches(S)) and the relative accuracy between training the machine leaning model on only one of these domains versus training on two or three of the domains. For example, when seeking to classify an art painting of an animal based on a machine learning model trained only on the sketch domain (see the “S->A” label in FIG. 2), the accuracy was under 50%. However, when the machine learning model was trained on two domains including the sketch domain and the photo domain (see the “SP->A” label in FIG. 2), the accuracy rose to above 70%. When the machine learning model was trained on three domains including the sketch domain, the photo domain, and the cartoon domain (see the “SPC->A” label in FIG. 2), the accuracy rose to above 80%. Note the various improvements in accuracy for each category of data from cartoons, photos, and sketches as well.

As a practical issue, incorporating data from multiple training domains, while improving accuracy, is not always possible due to the need to acquire data which can be costly or there may be privacy issues. An even bigger challenge, which is different from the challenge of multi-source domain generalization, is that using single source generalization techniques is prone to overfitting in the machine learning model, which reduces accuracy.

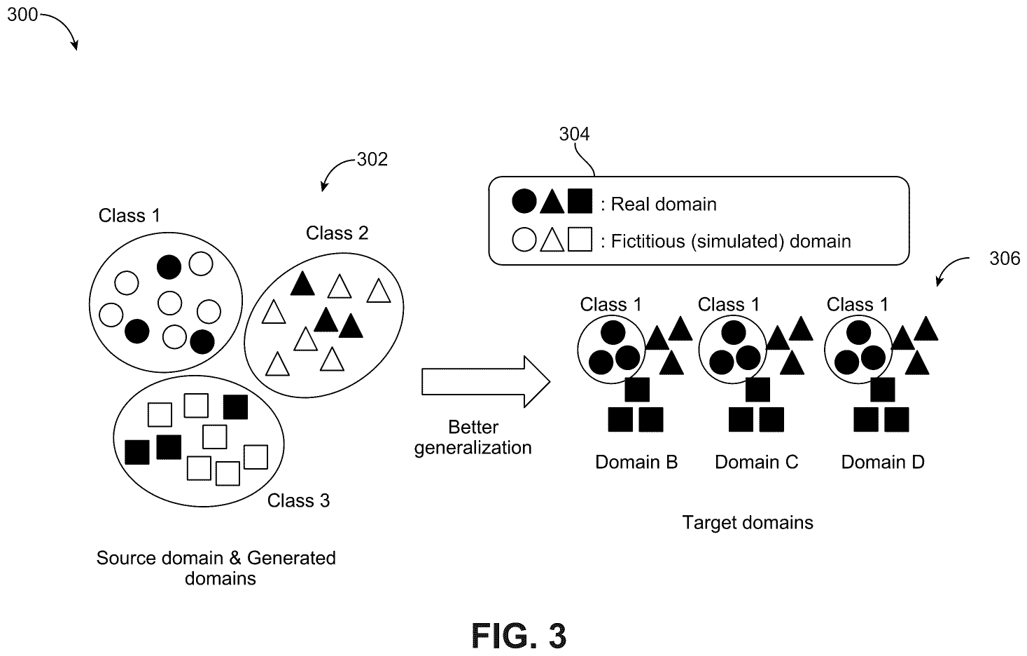

FIG. 3 illustrates an approach 300 showing the motivation and problems associated with single domain generalization. Data augmentation is one proposed solution to improve the robustness of machine learning models. Source domain and generated domains can have different classes of data, including the three classes 302 shown in FIG. 3. Some of the data (shown as filled in circles, triangles, and squares to represent the different classes of data) can be real domain data and some data (clear circles, triangles, and squares) can be fictitious or simulated domain data, as indicated by the key 304. The three classes 302 show both real domain data and simulated data. This approach simulates a multi-source domain generalization solution which, as shown in FIG. 2, can improve the accuracy of the machine learning model. However, even with better generalization and when data is processed in various target domains 306 (including target domains B, C and D), the approach 300 shown in FIG. 3 can be difficult to use in a single-domain generalization context.

Most of the existing work in this area focuses on generating effective fictitious target distributions by adversarial learning. The objective here is that generated images should have a different style from the original image. This focuses on achieving effectiveness in the accuracy of the trained model. However, another objective is that the images should have the same semantic information or class-specific information as the original image. This concept focuses on the goal of safety where, such as in the medical imaging context, the classification is sufficiently accurate in that it can impact a patient's health. It can be difficult to balance these two objectives. In some cases, the training design for adversarial learning can be complicated. Some approaches include up to eight objectives and require rigorous tinkering of hyper-parameters to converge.

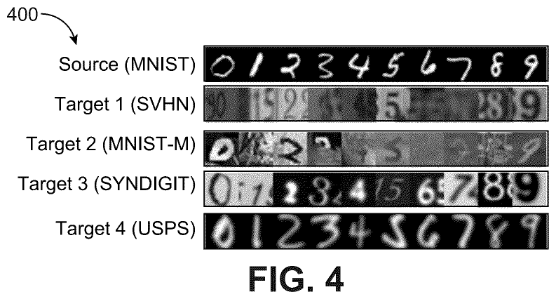

Another approach is manually designed data augmentation. FIG. 4 illustrates this approach in which expertise and manual work are required to select augmentation types and magnitude due to domain-dependent issues. For example, as shown in FIG. 4, source data and sets of target data 400. The source data can include a line of numbers. Augmenting this data in various ways can require manual work. Various parameters or types of adjustment can be made (e.g., identity, rotation, posterize, sharpness, translate-x, translate-y, autocontrast, solarize, contrast, shear-x, equalize, color, brightness, shear-y). With various different types of datasets, different performance gaps can occur. For example, using this approach, various data sets can be augmented by color jittering the data and in another example without color jittering. In one study, the performance gap between color jittering and without color jittering for data including digits as shown in FIG. 4 caused a reduction in accuracy. Other datasets such as PACS (a dataset including four domains: art painting, cartoon, photo, sketch with objects from seven classes: dog, elephant, giraffe, guitar, house, horses, person), and VLCS (a dataset that includes images from four other datasets covering five classes: bird, car, chair, person, and dog), resulted in various degrees of improvement in the performance gap. Another “Office Home” data set which includes office and home images had a more severe reduction in the performance gap.

FIG. 4 also shows various target images for different datasets or approaches that can be compared to other approaches such as adversarial learning. For example, using learned policies for different datasets, such as AutoAug (automatic augmentation), CVPR19 (Computer Vision and Pattern Recognition), different approaches such as Target 1 (which uses the SVHN dataset which includes street view house numbers) produce a particular style of numbers as shown in FIG. 4. Target 2 involves the MNIST-M (Modified National Institute of Standards and Technology) dataset with the numbers shown. Target 3 uses a SYNDIGIT (synthetic digits) dataset and produces the numbers shown in FIG. 4. Finally, Target 4 uses a USPS (U.S. Postal Service) dataset and produces the style of numbers shown. Applying these various datasets for data augmentation in general is actually less effective than using adversarial data augmentation in single domain generalization. Therefore, there is continued room for improving the diversity of augmented samples as shall be discussed in more detail below.

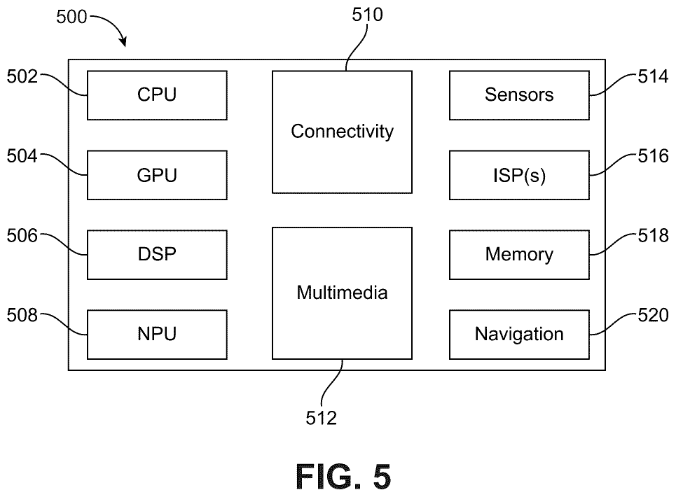

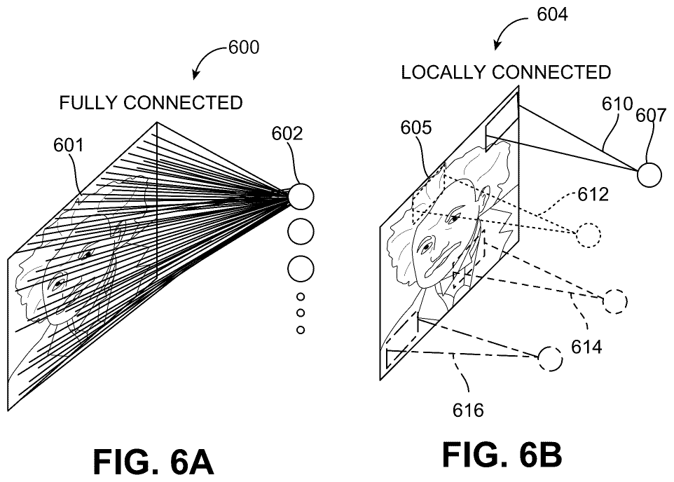

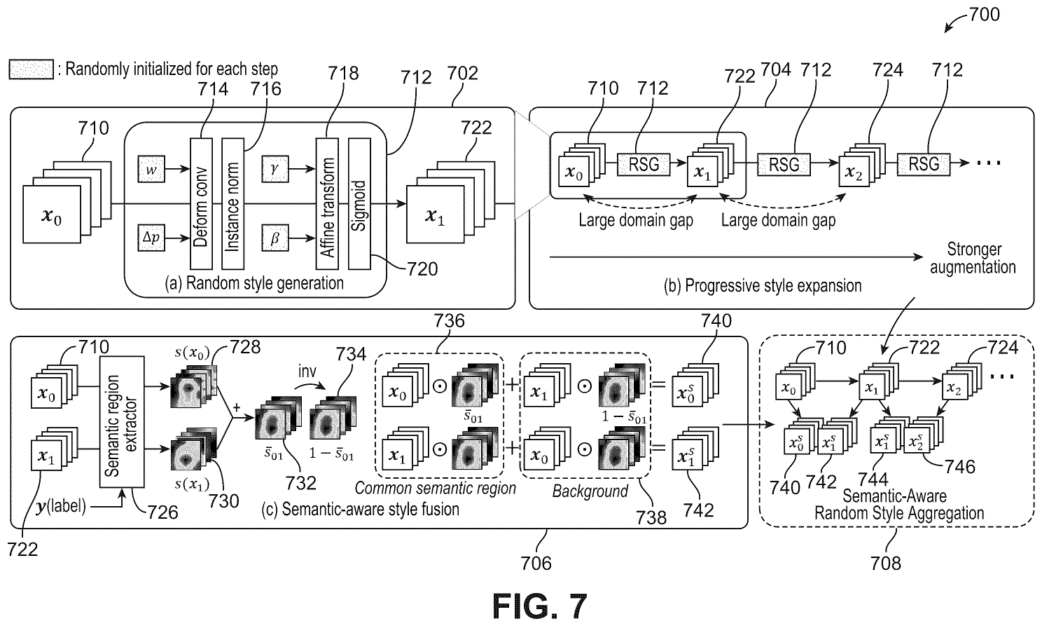

This disclosure will next describe some computer hardware and software components in FIGS. 5 and 6A, 6B that can be used implement the concepts related to semantic-aware random style aggregation which will be introduced with reference to FIG. 7. Systems, apparatuses, electronic devices, methods (also referred to as processes), and computer-readable media (collectively referred to herein as “systems and techniques”) are described herein for providing a semantic-aware random style aggregation for single domain generalization. A goal of this approach is to improve the process of generating augmented data from a distribution of a single domain of source data using a data augmentation and aggregation approach that provides a strong baseline that outperforms the existing data augmentation methods and without adversarial learning.

Various aspects of the present disclosure will be described with respect to the figures. FIG. 5 illustrates an example implementation of a system-on-a-chip (SOC) 500, which may include a central processing unit (CPU) 502 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 508, in a memory block associated with a CPU 502, in a memory block associated with a graphics processing unit (GPU) 504, in a memory block associated with a digital signal processor (DSP) 506, in a memory block 518, and/or may be distributed across multiple blocks. Instructions executed at the CPU 502 may be loaded from a program memory associated with the CPU 502 or may be loaded from a memory block 518.

The SOC 500 may also include additional processing blocks tailored to specific functions, such as a GPU 504, a DSP 506, a connectivity block 510, which may include fifth generation (5G) connectivity, fourth generation long term evolution (4G LTE) connectivity, Wi-Fi connectivity, USB connectivity, Bluetooth connectivity, and the like, and a multimedia processor 512 that may, for example, detect and recognize gestures. In one implementation, the NPU is implemented in the CPU 502, DSP 506, and/or GPU 504. The SOC 500 may also include a sensor processor 514, image signal processors (ISPs) 516, and/or navigation module 520, which may include a global positioning system. In some examples, the sensor processor 514 can be associated with or connected to one or more sensors for providing sensor input(s) to sensor processor 514. For example, the one or more sensors and the sensor processor 514 can be provided in, coupled to, or otherwise associated with a same computing device.

The SOC 500 may be based on an ARM instruction set. In an aspect of the present disclosure, the instructions loaded into the CPU 502 may comprise code to search for a stored multiplication result in a lookup table (LUT) corresponding to a multiplication product of an input value and a filter weight. The instructions loaded into the CPU 502 may also comprise code to disable a multiplier during a multiplication operation of the multiplication product when a lookup table hit of the multiplication product is detected. In addition, the instructions loaded into the CPU 502 may comprise code to store a computed multiplication product of the input value and the filter weight when a lookup table miss of the multiplication product is detected. SOC 500 and/or components thereof may be configured to perform image processing using machine learning techniques according to aspects of the present disclosure discussed herein. For example, SOC 500 and/or components thereof may be configured to perform semantic image segmentation and/or object detection according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 6A illustrates an example of a fully connected neural network 600. In a fully connected neural network 600, a neuron in a first layer 601 may communicate its output to every neuron in a second layer 6-2, so that each neuron in the second layer will receive input from every neuron in the first layer. FIG. 6B illustrates an example of a locally connected neural network 604. In a locally connected neural network 604, a neuron in a first layer 605 may be connected to a limited number of neurons in the second layer 607. More generally, a locally connected layer of the locally connected neural network 604 may be configured so that each neuron in a layer will have the same or a similar connectivity pattern, but with connections strengths that may have different values (e.g., 610, 612, 614, and 616). The locally connected connectivity pattern may give rise to spatially distinct receptive fields in a higher layer, as the higher layer neurons in a given region may receive inputs that are tuned through training to the properties of a restricted portion of the total input to the network.

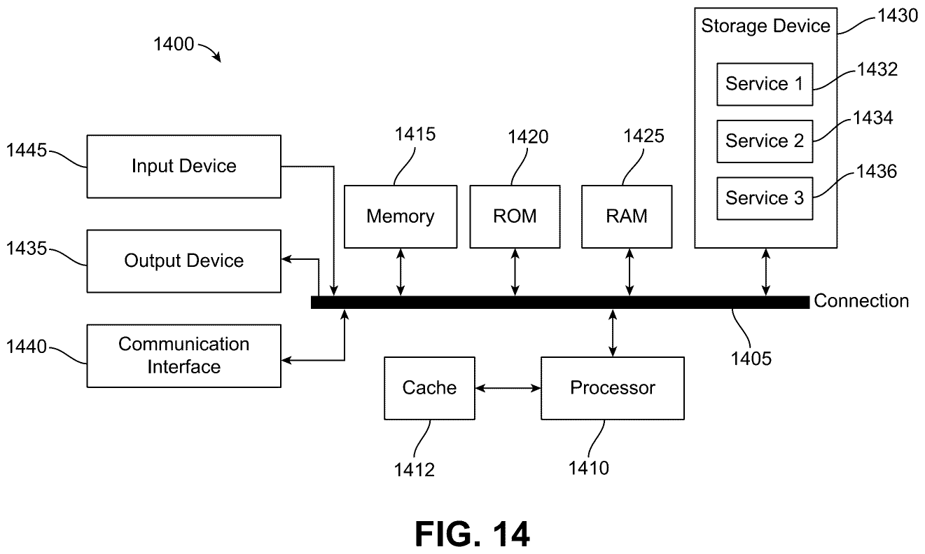

FIG. 7 is a block diagram illustrating various aspects of semantic-aware random style aggregation framework 700, in accordance with some examples disclosed herein. There are multiple portions involved in this new process of generating augmented data. The first portion 702 shown in FIG. 7 involves a random style generator engine 712 operating on training data X₀710. A second portion can include progressive style expansion engine 704. A third portion can include semantic-aware style fusion engine 706. A final portion can include semantic-aware random style aggregation engine 708. Each of these phases can be implemented as a software module or respective engine operating on an electronic device (which can be the SOC 500 from FIG. 5 or the electronic device 1400 shown in FIG. 14).

An electronic device (e.g., SOC 500 in FIG. 5, electronic device 1400 in FIG. 14, etc.) can perform various steps using instructions stored on a computer-readable device which cause a processor (e.g., CPU 502) to perform one or more operations. The operations can include augmenting, via a random style generator engine 712 (which can also be referred to as a random style generator 712) having at least one randomly initialized layer 714, training data X₀710 used to generate augmented training data X₁722 and aggregating data with a plurality of styles from the augmented training data to generate aggregated training data. The electronic device can perform further operations including applying semantic-aware style fusion engine 706 to the aggregated training data to generate fused training data and adding the fused training data as fictitious samples to the training data to generate updated training data for training a neural network or machine learning model. In one aspect, the electronic device may train a single network with only cross-entropy loss.

This disclosure defines the problem setting and notations used herein. Source data X₀ 710 is observed from a single domain S={x⁽ⁱ⁾, y⁽ⁱ⁾}^{Ns}ᵢ₌₁, where x⁽ⁱ⁾, y⁽ⁱ⁾ is the i-th image and class label, and Ns represents the number of samples in the source domain. The goal of single domain generalization is to learn a domain-agnostic model with only S to correctly classify the images from an unseen target domain. In this case, as the training objective, one example approach can be to use the empirical risk minimization (ERM) as Equation 1 as follows:

$$arg {min}_{φ} \frac{1}{{N}_{S}} {\sum }_{i = 1}^{{N}_{S}} l ( {f}_{φ} ( {x}^{( i )} ) , {y}^{( i )} ) \qquad Equation 1$$

where f(·) is the base network including a feature extractor and a classifier, ϕ is the set of the parameters of the base network, and 1 is a loss function measuring prediction error. After aggregating various random styles, the training of the single neural network can be performed by minimizing the empirical risk as in Equation 1. In one aspect, the approach utilizes only cross-entropy loss. Although ERM showed significant achievements on domain generalization datasets for multiple source domains, using the vanilla empirical risk minimization only with the single source domain S could be sub-optimal and is prone to overfitting. In order to derive domain-agnostic feature representations, this disclosure concentrates on aggregating samples of diverse styles in a mini-batch. More specifically, this disclosure introduces the semantic-aware random style Aggregation (SARSA) framework 700, which includes one or more of the following three steps as described herein: a) random style generation; b) progressive style expansion; and c) semantic-aware style fusion. The disclosed data augmentation and aggregation approach provides a strong baseline that outperforms the existing data augmentation methods without complicated adversarial learning.

In the example of FIG. 7, the various portions of the system or specific engines 702, 704, 706, 708, 712 can be part of or configured to operate on the electronic device (e.g., SOC 500, electronic device 1400, etc.). In some cases, one or more of the various portions or engines 702, 704, 706, 708, 712 can be located remotely from the electronic device (e.g., the random style generator engine 712 can be included in one or more cloud-based servers). In such cases, the random style generator engine 712 can communicate with the electronic device (e.g., SOC 500, electronic device 1400, etc.) via a wired or wireless network. Any such configuration is contemplated as within the scope of this disclosure.

As shown in FIG. 7, the original source data X₀ 710 is provided to the random style generator engine 712. To generate a new image from the input image or original source data X₀ 710, the random style generator engine 712 can include several randomly initialized layers 714, 716, 718. The random style generator engine 712 can randomly transform the texture, contrast, and brightness of a given image or data. For example, a randomly initialized deformable convolution layer 714 can operate as follows to perform texture modification of input data X₀ 710. Random weight data “w” can be provided as part of an initialization in each step for use with the randomly initialized deformable convolution layer 714.

For texture modification, the concept of random convolution is applied. The random convolution layer 714 can preserve large shapes generally indicating the image semantics while distorting the small shapes as local texture. In some cases, the system can use a kernel of a certain size (e.g., a small kernel size) to make the random style generator engine 712 suitable for texture modification since it will not damage the semantic information severely. The random convolution operation to relax the constraints on a fixed regular grid of data (related to the structure of the training data X₀ 710) and create more diverse textures. FIG. 7 shows the deformable convolution layer 714 with randomly initialized offsets Δp, which is a generalized version of the random convolution layer. For simplicity, the process omits the index i of the image x(i) and assume a 2D deformable convolution operation without considering the channel. An illustrative example of an equation is provided below that can illustrate the operation of the randomly initialized deformable convolution layer 714:

$${x}^{′} [ {i}_{0} , {j}_{0} , {c}_{out} ] = {\sum }_{{i}_{n} , {j}_{n} , {c}_{i n}} {w}_{{c}_{o u t}} [ {i}_{n} , {j}_{n} , {c}_{i n} ] \cdot x [ {i}_{0} + {i}_{n} + Δ {i}_{n} , {j}_{0} + {j}_{n} + Δ {j}_{n} , {c}_{i n} ] \qquad Equation 2$$

where w represents weights of the convolution kernel, and Δiₙ, Δjₙ are offsets of deformable convolution. Each location (i₀, j₀) on the output image x′ is transformed by the weighted summation of weights w and the pixel values on irregular locations (i₀+iₙ+Δiₙ, j₀+jₙ+Δjₙ) of the input image x. When all offsets Δiₙ, Δjₙ are allocated to zero-values, Equation 2 is similar to random convolution. Both weights w and offsets Δiₙ, Δjₙ are randomly initialized for each mini-batch. Since the offsets in deformable convolution can be considered as an extremely light-weight spatial transformer in an STN (spatial transformer network), it can generate more diverse samples.

In some aspects, the randomness-based (e.g., network-free) data augmentation can avoid the semantic consistency of the trained network. With respect to properties of the random convolution layer, the size of the kernel (e.g., convolutional filter) determines the smallest shape it can preserve. As noted above, if a small kernel size is used for the kernel (e.g., convolution layer), the random convolution layer can preserve large shapes that typically indicate the image semantics while distorting the small shapes as local texture, which may increase diversity. With respect to properties of properties of deformable convolution layer, random offsets may relax the constraints on the (fixed) regular grid and can make it more flexible to apply, which may create more of a diverse or different set of textures. The offset in the deformable convolution may be considered as an extremely light-weight spatial transformer in STN in some cases. The following represents a generalized version of random convolution (when Δpₙ=0, it is the same as random convolution):

old: [symbol] ={(−1, −1), (−1,0), . . . , (0, 1), (1,1)}(regular grid of 3×3 kernel)

xₜ[p₀]=Σ(pₙ∈R)w[pₙ]·x[p₀+pₙ+Δpₙ]

Equation 3

The random style generator engine 712 can thus perform deformable convolution by applying random weights (w) and offsets (Ap) to the deformable convolutional layer which together can be called a randomly initialized deformable convolution layer 714. A step of augmenting the training data further can include augmenting texture data in the training data using a randomly initialized deformable convolution layer 714. The process can also include augmenting one or more of texture data, contrast data, and/or brightness data of the plurality of training images. The training data can include a plurality of training images but in other aspects does not need to be image data. As noted above, the type of data used can be text, speech, multimodal, graffiti data on a touch-sensitive display, motion, gesture data (hand motion or facial motion, etc.), or a combination of such data.

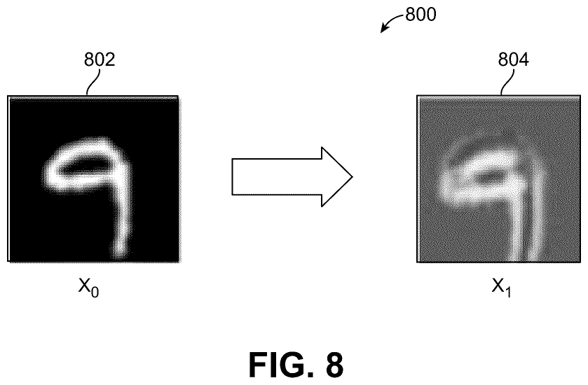

The Δp shown in the first portion 702 of FIG. 7 can represent deformable offsets which can provide for more diverse samples. One or more of weights (w) and offsets (Δp) can be randomly initialized for each step using the randomly initialized deformable convolution layer 714. The random offsets can relax the constrains on a fixed regular grid and make the process more flexible to apply and thus create more different textures. One benefit of this approach is that the randomly initialized deformable convolution layer 714 can preserve large shapes that usually indicate the image semantics while distorting the small shapes as local texture which will create the diversity in the generated data. The process of augmenting, via the random style generator engine 712, training data to generate augmented training data can include preserving semantic data in the training data while distorting non-semantic data to increase data diversity. FIG. 8 illustrates an example of texture modification 800 from original data X₀ 802 to generated data X₁ 804, in accordance with some examples.

Depending on the distribution of the random convolution parameters, not only the texture but also the color can be adjusted. In some cases, problems can occur with output images whose values often went out of bounds or got saturated after the randomly initialized deformable convolution layer 714. This problem can be exacerbated during the style expansion engine 704, discussed below. Therefore, a modification can be included to adjust for contrast and brightness changes. This modification can involve using the instance normalization layer 716 with randomly initialized affine transformation parameters of an affine transformation layer 718 and the application of a sigmoid function 720.

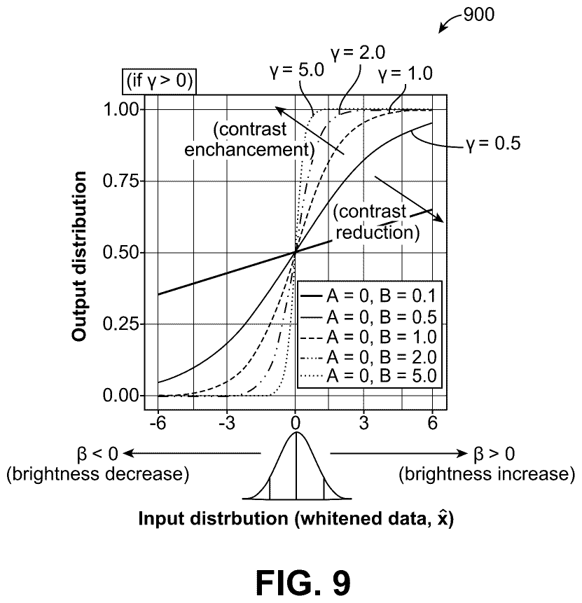

In FIG. 9 illustrates how contrast and brightness modification 900 can be implemented in the random style generator engine 712. The input distribution is along the x-axis and output distribution is along the y-axis. The γ parameter represents contrast enhancement for values greater than zero (such as for values at or above 1.0) and contrast reduction for smaller γ values approaching zero, such as 0.5 or 0.1. The β parameter can cause a decrease in brightness for values less than zero and an increase in brightness for values greater than zero. The process of augmenting the training data can include randomly initializing one or more of the brightness parameter and the contrast parameter in an affine transformation layer 718 of the random style generator engine 712.

The random style generator engine 712 can include an instance normalization module g(·) 716 and randomly initialized affine transformation parameters γ and β of the affine transformation layer 718 and the use of a sigmoid function h(·) 720. Given an input image x′, an instance normalization layer can transform the channel-wise whitened images \hat{x}[i, j, c] using affine parameters γ_{c}, β_{c} as follows. In some aspects, the random style generator engine 712 can apply the following Equations 4-9 to perform some of the operations described herein. In one aspect, the process can be considered as sigmoidal non-linearity contrast adjustment or gamma correction.

x′′′[i, j, c]=γ_{c}\hat{x}[i, j, c]+β_{c}

Equation 4

where μ_{c} and σ_{c}² are the per-channel mean and variance, respectively as shown in Equations 6 and 7 below.

$$\hat{x} [ i , j , c ] = \frac{{x}^{′} [ i , j , c ] - {μ}_{c}}{\sqrt{{σ}_{c}^{2} + ϵ}} \qquad Equation 5$$

$${μ}_{c} = \frac{{\sum }_{i , j} {x}^{′} [ i , j , c ]}{H \cdot W} \qquad Equation 6$$

$${σ}_{c}^{2} = \frac{{\sum }_{i , j} {( {x}^{′} [ i , j , c ] - {μ}_{c} )}^{2}}{H \cdot W} \qquad Equation 7$$

$$g ( x ) = γ \hat{x} + β , h ( x ) = \frac{1}{1 + {e}^{- x}} \qquad Equation 8$$

$$h ( g ( x ) ) = \frac{1}{1 + {e}^{- γ \hat{x} - β}} \qquad Equation 9$$

According to the above Equations, the whitening is performed using the mean and variance, μ_{c} and σ_{c}². Then, the sigmoid function 720 transforms the normalized image x″ into a range between 0 and 1 as g(x″)=1/(1+e^{-x″}). This modeling can be interpreted as sigmoidal non-linearity contrast adjustment h(u)=1/(1+e^{-(γu+β)}), which is known as a form of gamma correction. Note that gamma correction can be performed for each channel. It is possible to aggregate multiple images by randomly creating styles with the proposed random style generator engine 712 but still the style diversity can be somewhat limited. Therefore, the disclosed approach focuses on improving the diversity of data augmentation based on the random style generator engine 712.

The next portion of FIG. 7 is the progressive style expansion engine 704 in which to improve diversity, the electronic device (e.g., SOC 500, electronic device 1400, etc.) creates effective fictitious target distributions that are largely different from the source distribution X₀ 710. To improve the style diversity, the disclosed approach creates effective fictitious targets distributions with significant differences from the source domain X₀ 710. Repeatedly passing transformed images X₁ 722 through the random style generator engine 712 can progressively enlarge the domain gap. According to the characteristics of random convolution, the image distortion becomes severe as the kernel size is increased. In particular, thanks to the offset of the randomly initialized deformable convolution layer 714, more diverse images can be generated during the style expansion process. This is different from simply increasing the kernel size of the randomly initialized deformable convolution layer 714 and it is consistent with generating effective fictitious target distributions containing hard samples. Through this style expansion engine 704, the electronic device (e.g., SOC 500, electronic device 1400, etc.) can aggregate several distorted images with various severity levels.

As shown in FIG. 7, there can be a large domain gap between the source distribution X₀ 710 and the first-generation of a fictitious target distribution X₁ 722. What is shown as part of the progressive style expansion engine 704 is that by repeatedly passing the new distribution of data through the random style generator engine 712, the random style generator engine 712 can gradually enlarge the domain shift. A plurality of styles can be generated by passing the augmented training data through the random style generator engine 712. The data distribution X₂ 724 can represent a second generation of data that has been passed through the random style generator 712 twice. The process of aggregating data with a plurality of styles from the augmented training data to generate the aggregated training data can thus be performed by passing a latest set of augmented training data (which can be represented by X₂ 724 in FIG. 7) through the random style generator 712.

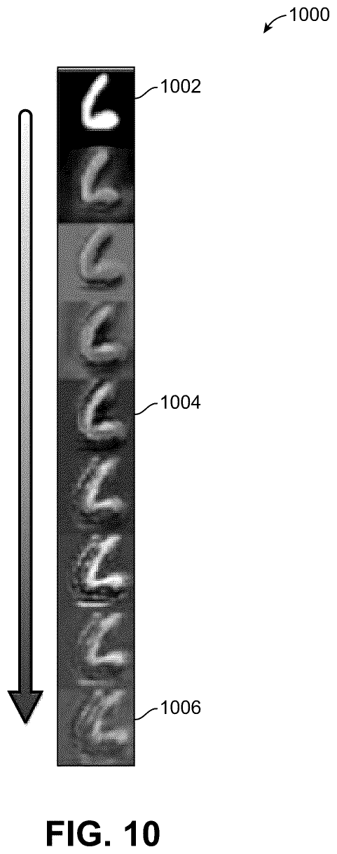

FIG. 10 illustrates a progressive style expansion concept 1000 from original data X₀ 1002 (the number “6”) to generated data 1004 and to final data 1006. As the image of the number “6” in FIG. 10 changes according to the characteristics of random convolution as described herein, the distortion in the image becomes more severe as the kernel size is increased. The shape of the object (the number “6” in this example) can represent the semantic information which can start to become obscured as is shown in FIG. 10. The kernel size is the size of a grid of data used to train up the machine learning model. Common kernel sizes are 3×3 or 5×5. Any size is contemplated as within the scope of this disclosure. A size of at least one kernel of the neural network may be based on a size of an image or data of a plurality of training images or a plurality of data.

Next, the system involves aggregating images with various styles generated by passing the data through the random style generator engine 712. In a multi-domain generalization (DG) context, this domain aggregation model can provide an effective baseline of data.

In some cases, the progressive style expansion can expand weak augmented images into strong augmented images by repeatably passing data (e.g., input images and augmented images) through the generator. For example, the system can progressively enlarge the domain shift by repeatably passing the data through the generator. According to characteristics of random convolution, the image distortion may become severe as the kernel size is increased. For example, the image distortion can be consistent with generating effective fictitious target distributions containing “hard” samples. The system may aggregate images with various styles generated by randomly initialized neural networks. In multi-DG, this domain aggregation model is regarded as an effective baseline.

Even if the kernel size or an offset value is adjusted, there is inevitably a domain gap between the input image in any iteration and the generated image in the semantic space. As the number of generated images increases, the distribution of the generated sample becomes farther away from the existing source distribution. This makes it difficult for the machine learning model to learn images. Note the progressive style expansion engine 704 which highlights the large domain gab between sets of distributions. To bridge the domain gap between different distributions, the system disclosed herein can use the semantic-aware style fusion method such that instead of interpolating features in semantic space, the system adopts of method of combining class-specific semantic information in an image space. In one aspect, the system can combine class-specific semantic information extracted from aggregated training data in the image space. The semantic-interpolated image encourages the model to extract the meaningful semantic information in hard samples. In one aspect, the augmented training data can include a randomly generated new style from the training data but maintains data semantics. In another aspect, aggregating the images with the various styles from the augmented training data to generate the aggregated training data can include using random style aggregation in which the various styles are selected randomly. The system after obtaining updated training data can train the neural network or a machine learning model using the updated training data and in one aspect using cross-entropy loss.

The semantic-aware tyle fusion engine 706 can include or perform a number of different operations. The process of applying the semantic-aware style fusion engine 706 to the aggregated training data to generate the fused training data can include extracting semantic regions via a semantic region extractor 726 from the training data and the augmented training data. The semantic regions can be used in the semantic-aware style fusion engine 706 with the training data. The semantic region extractor 726 can receive the source data X₀ 710 and the first-generation distribution X₁ 722 and generate extracted regions s(X₀) 728 and s(X₁) 730. The regions s(X₀) 728 and s(X₁) 730 are combined together into a combined or aggregated region ŝ₀₁. The aggregated region ŝ₀₁ is then inverted to generate an inverted aggregated region 1−ŝ₀₁. The original source data X₀ 710 can be elementwise multiplied (or some other mathematical operation) with the aggregated region ŝ₀₁ and the first-generation distribution X₁ 722 can be elementwise multiplied with the aggregated region ŝ₀₁ to generate a common semantic region 736. The original source data X₀ 710 can be elementwise multiplied (or some other mathematical operation) with the inverted aggregated region 1−ŝ₀₁ and the first-generation distribution X₁ 722 can be elementwise multiplied with the inverted aggregated region 1−ŝ₀₁ to generate a background region 738. The common semantic region 736 and the background region 738 can be combined to yield fused training data such as a first fused distribution x^{s}₀ 740 and a second fused distribution x^{s}₁ 742.

As the number of style expansions in the input image increases, the shape of the object representing the semantic information also becomes obscured as shown by an object in final data 1006 in FIG. 10 relative to a source object in original data X₀ 1002. The distribution of the generated sample of the final data 1006 becomes farther away from the existing source distribution of the original data X₀ 1002. This makes it difficult for the machine learning model to learn semantic information of the images. To bridge the domain gap between different distributions, this disclosure includes a semantic-aware style fusion engine 706 which can, in one example be based on Grad-CAM (gradient-weighted class activation mapping).

Even if the constraints are imposed in the random style generator, there is inevitably a domain gap between distributions of different styles in the semantic space. To bridge the domain gap between different distributions, the system can employ vanilla mixup (see, e.g., Hany Farid, Fundamentals of image processing, Dartmouth, 2008). Even this simple solution has the effect of mixing styles, which contributes to increasing the diversity of the augmented domain from the source domain. Moreover, this idea can be developed into a more advanced interpolation scheme, considering the spatial relationships. A suggested approached is a semantic-aware style fusion manner based on saliency maps as follows. Equation 10 includes the following operations:

$${x}_{i}^{s} = {\overline{s}}_{i j} ⊙ {x}_{i} + ( 1 - {\overline{s}}_{i j} ) ⊙ {x}_{j} \qquad Equation 10$$

$${x}_{j}^{s} = {\overline{s}}_{i j} ⊙ {x}_{j} + ( 1 - {\overline{s}}_{i j} ) ⊙ {x}_{i}$$

$${\overline{s}}_{i j} = v [ \frac{s ( {x}_{i} ) + s ( {x}_{j} )}{2} ] ∈ [ 0 , 1 ]$$

In Equation 10, v[·] is a min-max normalization function, s(·) is the Grad-CAM scope mapping function or the salient region extractor and \textcircled{·}can be an elementwise multiplication function. Synthesizing class-specific semantic regions directly into the images as cues can help the machine learning model learn unseen semantic information from distorted images. The above-noted equations 1-10 provide illustrative examples of how the mathematical operations can be applied, but other operations are contemplated as well.

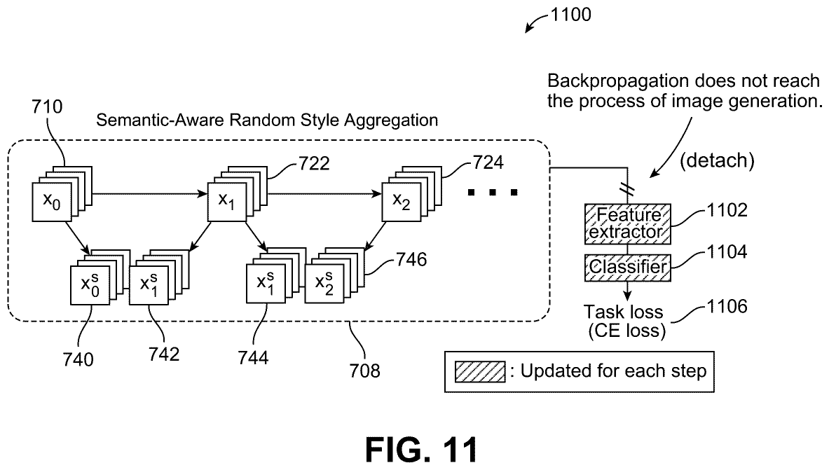

FIG. 11 is a diagram 1100 illustrating an example of semantic-aware random style aggregation 708 and feature extraction, in accordance with some examples. The original distribution data X₀ 710 and the first-generation distribution data X₁ 722 can be used as described above to generate the first fused distribution x^{s}₀ 740 and a second fused distribution x^{s}₁ 742. The first-generation distribution data X₁ 722 and the second-generation distribution data X₂ 724 can be used to generate additional fused distribution X₁ 744 and x^{s}₂ 746. The fictitious samples can be augmented by the semantic-aware random style aggregation engine 708 as shown in FIG. 11. Backpropagation as part of the training process can be configured such that it does not reach the process of image generation in that it is detached from feature extraction process 1102 and classification process 1104. One example output of these processes is a cross-entropy (CE) loss 1106 which can be used as part of training the neural network or machine learning model of the semantic-aware random style aggregation framework 700. The feature extraction process 1102 and the classification process 1104 can be updated for each step.

The approach disclosed herein bridges the domain gap between easy-to-classify samples (e.g., image of the original data X₀ 1002 in FIG. 10) and difficult-to-classify samples (e.g., the image of the final data 1006 in FIG. 10) with a semantic-aware style fusion technique to create semantic-interpolated images (represented by distributions 740, 742, 744, 746) by combining the class-specific semantic information of both images. While image data is used as an example herein, other types of data can be used in the process and this disclosure is not limited to image data.

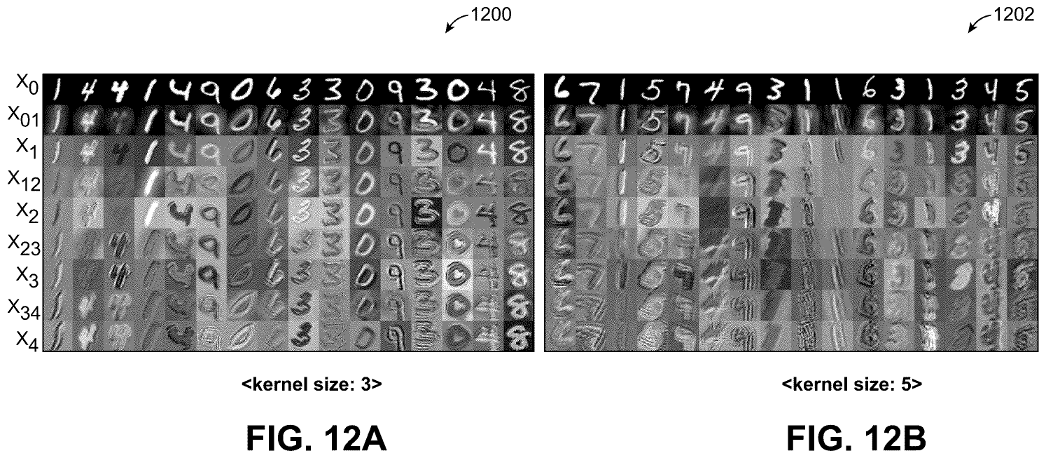

FIG. 12A illustrates qualitative results 1200 of generating data with a kernel size of 3 (or a grid size of 3×3), in accordance with some examples. Various distributions of data are shown from the original distribution Xo through various fictitious or generated distributions X₀₁, X₁, X₁₂, X₂, X₂₃, X₃, X₃₄, X₄. FIG. 12B illustrates an example of various distributions 1202 with a kernel size of 5 and from the original X₀ through various fictitious or generated distributions X₀₁, X₁, X₁₂, X₂, X₂₃, X₃, X₃₄, X₄.

The semantic-aware random style aggregation approach disclosed herein can be used in many different applications. For example, domain generalization can be used for visual perception such as, without limitation, object recognition, object detection and object or image segmentation. In such applications, various data augmentation methods are required and expected to be effective. The concepts can be used in on-device learning for domain adaptation or few-shot learning. This can aid these approaches by augmenting the target data. Furthermore, other applications can implement the concepts disclosed herein such as personalization in speech recognition, facial recognition, biometrics such as fingerprint recognition and other types of data processing. The disclosed approach can prevent adversarial attacks and enable a more robust learning process for the various models.

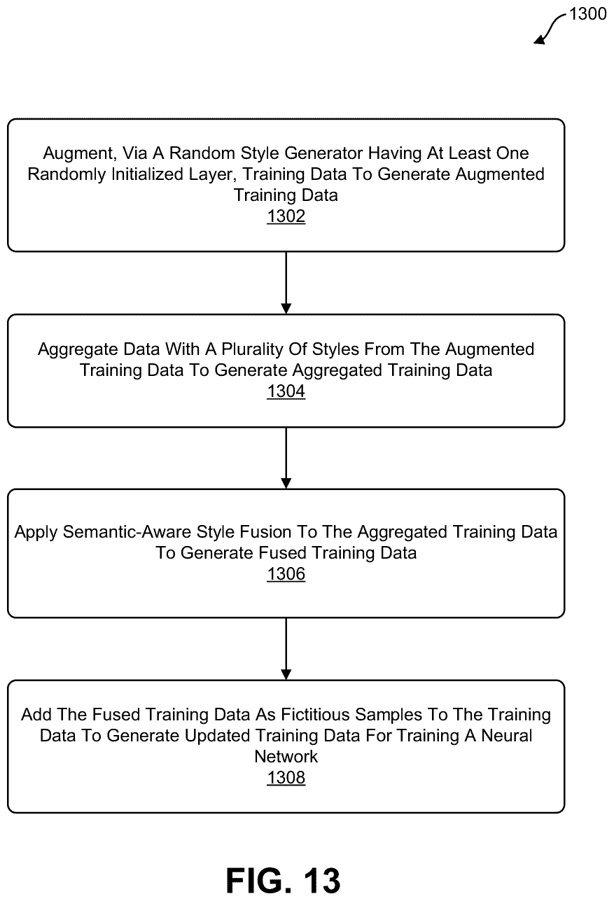

FIG. 13 is a flow diagram illustrating an example of a process 1300 for performing semantic-aware random style aggregation. The process can be performed, for example, by the SOC 500 of FIG. 5 or the device 1400 of FIG. 14.

At block 1302, the process 1300 includes augmenting, via a random style generator having at least one randomly initialized layer, training data (i.e., image data or other types of data) to generate augmented training data. In some aspects, the training data includes a plurality of training images. In such aspects, a size of at least one kernel of the neural network may be based on a size of an image of the plurality of training images. In some cases, augmenting (e.g., via a SOC 500 or device 1400) the training data can include: augmenting texture data, contrast data, and brightness data of the plurality of training images. In some examples, augmenting the training data further can include randomly initializing a brightness parameter and a contrast parameter in an affine transformation layer of the random style generator. In some aspects, augmenting the training data further can include performing deformable convolution, applying a random convolutional layer, and applying a deformable convolutional layer. In some cases, augmenting the training data further can include augmenting texture data in the training data using a randomly initialized deformable convolution layer. In some examples, one or more of weights and offsets are randomly initialized using the randomly initialized deformable convolution layer. In some cases, augmenting the training data further can include augmenting contrast data in the training data and brightness data in the training data using instance normalization, affine transformation, and a sigmoid function. In some examples, at least one parameter of the affine transformation is randomly initialized.

In some cases, augmenting (e.g., via a SOC 500 or device 1400) the training data using the random style generator to generate the augmented training data includes randomly initializing at least one weight and at least one offset to achieve texture modification of the training data. In some examples, augmenting the training data using the random style generator to generate the augmented training data includes preserving semantic data in the training data while distorting non-semantic data to increase data diversity. In some aspects, augmenting the training data using the random style generator to generate the augmented training data can include a randomly generated new style from the training data but maintains data semantics.

At block 1304, the process 1300 includes aggregating (e.g., via a SOC 500 or device 1400) data with a plurality of styles from the augmented training data to generate aggregated training data. In some aspects, aggregating the data with the plurality of styles from the augmented training data to generate the aggregated training data can include using random style aggregation in which the plurality of styles is selected randomly. In some cases, the plurality of styles is generated by passing the augmented training data through the random style generator. In some examples, aggregating data with a plurality of styles from the augmented training data to generate the aggregated training data is performed by passing a latest set of augmented training data through the random style generator.

At block 1306, the process 1300 includes applying (e.g., via a SOC 500 or device 1400) semantic-aware style fusion to the aggregated training data to generate fused training data. In some aspects, applying the semantic-aware style fusion to the aggregated training data to generate the fused training data further can include applying the semantic-aware style fusion to the training data to generate the fused training data. In some cases, applying the semantic-aware style fusion to the aggregated training data to generate the fused training data further can include extracting semantic regions from the training data and the augmented training data. In some examples, the semantic regions are used in the semantic-aware style fusion with the training data. In some aspects, applying the semantic-aware style fusion to the aggregated training data to generate the fused training data includes processing a common semantic region with the training data and the augmented training data to generate common semantic region data. In some cases, applying the semantic-aware style fusion to the aggregated training data to generate the fused training data includes processing inverted data with the training data and the augmented training data to generate background data. In some examples, applying the semantic-aware style fusion to the aggregated training data to generate the fused training data further can include combining the common semantic region data and the background data to generate the fused training data. In some aspects, applying the semantic-aware style fusion to the aggregated training data to generate the fused training data includes combining class-specific semantic information extracted from the aggregated training data in an image space.

At block 1308, the process 1300 includes adding (e.g., via a SOC 500 or device 1400) the fused training data as fictitious samples to the training data to generate updated training data for training a neural network. In some aspects, the process 1300 includes training (e.g., via a SOC 500 or device 1400) the neural network using the updated training data. In some cases, the process 1300 includes training the neural network using a cross-entropy loss.

In some examples, the processes described herein (e.g., process 1300 and/or any other process described herein) may be performed by a computing device, apparatus, or system. In one example, the process 1300 can be performed by a computing device or system having the computing device architecture of the electronic device 1400 of FIG. 14. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 1300 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1300 are illustrated as logical flow diagrams, the operation of which represents a sequence of operations that can be implemented in hardware, computer instructions, or a combination thereof In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 illustrates an example computing device architecture of an example electronic device 1400 which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of the electronic device 1400 are shown in electrical communication with each other using connection 1405, such as a bus. The example electronic device 1400 includes a processing unit (CPU or processor) 1410 and computing device connection 1405 that couples various computing device components including computing device memory 1415, such as read only memory (ROM) 1420 and random-access memory (RAM) 1425, to processor 1410.

The electronic device 1400 can include a cache of high-speed memory connected directly with, in close proximity to, or integrated as part of processor 1410. The electronic device 1400 can copy data from memory 1415 and/or the storage device 1430 to cache 1412 for quick access by processor 1410. In this way, the cache can provide a performance boost that avoids processor 1410 delays while waiting for data. These and other engines can control or be configured to control processor 1410 to perform various actions. Other computing device memory 1415 may be available for use as well. Memory 1415 can include multiple different types of memory with different performance characteristics. Processor 1410 can include any general-purpose processor and a hardware or software service, such as service 1 1432, service 2 1434, and service 3 1436 stored in storage device 1430, configured to control processor 1410 as well as a special-purpose processor where software instructions are incorporated into the processor design. Processor 1410 may be a self-contained system, containing multiple cores or processors, a bus, memory controller, cache, etc. A multi-core processor may be symmetric or asymmetric.

To enable user interaction with the electronic device 1400, input device 1445 can represent any number of input mechanisms, such as a microphone for speech, a touch-sensitive screen for gesture or graphical input, keyboard, mouse, motion input, speech and so forth. Output device 1435 can also be one or more of a number of output mechanisms known to those of skill in the art, such as a display, projector, television, speaker device, etc. In some instances, multimodal computing devices can enable a user to provide multiple types of input to communicate with the electronic device 1400. Communication interface 1440 can generally govern and manage the user input and computing device output. There is no restriction on operating on any particular hardware arrangement and therefore the basic features here may easily be substituted for improved hardware or firmware arrangements as they are developed.

Storage device 1430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1425, read only memory (ROM) 1420, and hybrids thereof. Storage device 1430 can include services 1432, 1434, 1436 for controlling processor 1410. Other hardware or software modules or engines are contemplated. Storage device 1430 can be connected to the computing device connection 1405. In one aspect, a hardware module that performs a particular function can include the software component stored in a computer-readable medium in connection with the necessary hardware components, such as processor 1410, connection 1405, output device 1435, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method (e.g., a processor-implemented method) of augmenting training data, the method comprising: augmenting, via a random style generator having at least one randomly initialized layer, training data to generate augmented training data; aggregating data with a plurality of styles from the augmented training data to generate aggregated training data; applying semantic-aware style fusion to the aggregated training data to generate fused training data; and adding the fused training data as fictitious samples to the training data to generate updated training data for training a neural network.

Aspect 2. The method of Aspect 1, wherein the training data includes a plurality of training images.

Aspect 3. The method of Aspect 2, wherein a size of at least one kernel of the neural network is based on a size of an image of the plurality of training images.

Aspect 4. The method of any of Aspects 1 to 3, wherein augmenting the training data comprises: augmenting texture data, contrast data, and brightness data of the plurality of training images.

Aspect 5. The method of any of Aspects 1 to 4, wherein augmenting the training data further comprises randomly initializing a brightness parameter and a contrast parameter in an affine transformation layer of the random style generator.

Aspect 6. The method of any of Aspects 1 to 5, wherein augmenting the training data further comprises performing deformable convolution, applying a random convolutional layer, and applying a deformable convolutional layer.

Aspect 7. The method of any of Aspects 1 to 6, wherein augmenting the training data further comprises augmenting texture data in the training data using a randomly initialized deformable convolution layer.

Aspect 8. The method of Aspect 7, wherein one or more of weights and offsets are randomly initialized using the randomly initialized deformable convolution layer.

Aspect 9. The method of any of Aspects 1 to 8, wherein augmenting the training data further comprises augmenting contrast data in the training data and brightness data in the training data using instance normalization, affine transformation, and a sigmoid function.

Aspect 10. The method of Aspect 9, wherein at least one parameter of the affine transformation is randomly initialized.

Aspect 11. The method of any of Aspects 1 to 10, wherein augmenting, via the random style generator, training data to generate augmented training data further comprises randomly initializing at least one weight and at least one offset to achieve texture modification of the training data.

Aspect 12. The method of any of Aspects 1 to 11, wherein augmenting, via the random style generator, training data to generate augmented training data further comprises preserving semantic data in the training data while distorting non-semantic data to increase data diversity.

Aspect 13. The method of any of Aspects 1 to 12, wherein the augmented training data comprises a randomly generated new style from the training data but maintains data semantics.

Aspect 14. The method of any of Aspects 1 to 13, wherein aggregating the data with the plurality of styles from the augmented training data to generate the aggregated training data further comprises using random style aggregation in which the plurality of styles is selected randomly.

Aspect 15. The method of any of Aspects 1 to 14, wherein the plurality of styles is generated by passing the augmented training data through the random style generator.

Aspect 16. The method of any of Aspects 1 to 15, wherein aggregating data with a plurality of styles from the augmented training data to generate the aggregated training data is performed by passing a latest set of augmented training data through the random style generator.

Aspect 17. The method of any of Aspects 1 to 16, wherein applying the semantic-aware style fusion to the aggregated training data to generate the fused training data further comprises applying the semantic-aware style fusion to the training data to generate the fused training data.

Aspect 18. The method of any of Aspects 1 to 17, wherein applying the semantic-aware style fusion to the aggregated training data to generate the fused training data further comprises extracting semantic regions from the training data and the augmented training data, wherein the semantic regions are used in the semantic-aware style fusion with the training data.

Aspect 19. The method of any of Aspects 1 to 18, wherein applying the semantic-aware style fusion to the aggregated training data to generate the fused training data further comprises processing a common semantic region with the training data and the augmented training data to generate common semantic region data.

Aspect 20. The method of any of Aspects 1 to 19, wherein applying the semantic-aware style fusion to the aggregated training data to generate the fused training data further comprises processing inverted data with the training data and the augmented training data to generate background data.

Aspect 21. The method of any of Aspects 19 or 20, wherein applying the semantic-aware style fusion to the aggregated training data to generate the fused training data further comprises combining the common semantic region data and the background data to generate the fused training data.

Aspect 22. The method of any of Aspects 1 to 21, wherein applying the semantic-aware style fusion to the aggregated training data to generate the fused training data further comprises: combining class-specific semantic information extracted from the aggregated training data in an image space.

Aspect 23. The method of any of Aspects 1 to 22, further comprising: training the neural network using the updated training data.

Aspect 24. The method of any of Aspects 1 to 23, further comprising: training the neural network using a cross-entropy loss.

Aspect 25. An apparatus for augmenting training data, comprising: at least one memory; and at least one processor coupled to at least one memory and configured to: augment, via a random style generator having at least one randomly initialized layer, training data to generate augmented training data; aggregate data with a plurality of styles from the augmented training data to generate aggregated training data; apply semantic-aware style fusion to the aggregated training data to generate fused training data; and add the fused training data as fictitious samples to the training data to generate updated training data for training a neural network.

Aspect 26. The apparatus of Aspect 25, wherein the training data includes a plurality of training images.

Aspect 27. The apparatus of any of Aspects 25 to 26, wherein a size of at least one kernel of the neural network is based on a size of an image of the plurality of training images.

Aspect 28. The apparatus of any of Aspects 25 to 27, wherein the at least one processor is configured to: augment texture data, contrast data, and brightness data of the plurality of training images.

Aspect 29. The apparatus of any of Aspects 25 to 28, wherein, to augment the training data, the at least one processor is configured to randomly initialize a brightness parameter and a contrast parameter in an affine transformation layer of the random style generator.

Aspect 30. The apparatus of any of Aspects 25 to 29, wherein, to augment the training data, the at least one processor is configured to perform deformable convolution, apply a random convolutional layer, and apply a deformable convolutional layer.

Aspect 31. The apparatus of any of Aspects 25 to 30, wherein, to augment the training data, the at least one processor is configured to augment texture data in the training data using a randomly initialized deformable convolution layer.

Aspect 32. The apparatus of Aspect 31, wherein one or more of weights and offsets are randomly initialized using the randomly initialized deformable convolution layer.

Aspect 33. The apparatus of any of Aspects 25 to 32, wherein, to augment the training data, the at least one processor is configured to augment contrast data in the training data and brightness data in the training data using instance normalization, affine transformation, and a sigmoid function.

Aspect 34. The apparatus of Aspect 33, wherein at least one parameter of the affine transformation is randomly initialized.

Aspect 35. The apparatus of any of Aspects 25 to 34, wherein, to augment, via the random style generator, training data to generate augmented training data, the at least one processor is configured to randomly initialize at least one weight and at least one offset to achieve texture modification of the training data.

Aspect 36. The apparatus of any of Aspects 25 to 35, wherein, to augment, via the random style generator, training data to generate augmented training data, the at least one processor is configured to preserve semantic data in the training data while distorting non- semantic data to increase data diversity.

Aspect 37. The apparatus of any of Aspects 25 to 36, wherein the augmented training data comprises a randomly generated new style from the training data but maintains data semantics.

Aspect 38. The apparatus of any of Aspects 25 to 37, wherein, to aggregate the data with the plurality of styles from the augmented training data to generate the aggregated training data, the at least one processor is configured to use random style aggregation in which the plurality of styles is selected randomly.

Aspect 39. The apparatus of any of Aspects 25 to 38, wherein the plurality of styles is generated by passing the augmented training data through the random style generator.

Aspect 40. The apparatus of any of Aspects 25 to 39, wherein, to aggregate data with a plurality of styles from the augmented training data to generate the aggregated training data, the at least one processor is configured to pass a latest set of augmented training data through the random style generator.

Aspect 41. The apparatus of any of Aspects 25 to 40, wherein, to apply the semantic-aware style fusion to the aggregated training data to generate the fused training data, the at least one processor is configured to apply the semantic-aware style fusion to the training data to generate the fused training data.

Aspect 42. The apparatus of any of Aspects 25 to 41, wherein, to apply the semantic-aware style fusion to the aggregated training data to generate the fused training data, the at least one processor is configured to extract semantic regions from the training data and the augmented training data, wherein the semantic regions are used in the semantic-aware style fusion with the training data.

Aspect 43. The apparatus of any of Aspects 25 to 42, wherein, to apply the semantic-aware style fusion to the aggregated training data to generate the fused training data, the at least one processor is configured to process a common semantic region with the training data and the augmented training data to generate common semantic region data.

Aspect 44. The apparatus of any of Aspects 25 to 43, wherein, to apply the semantic-aware style fusion to the aggregated training data to generate the fused training data, the at least one processor is configured to process inverted data with the training data and the augmented training data to generate background data.

Aspect 45. The apparatus of any of Aspects 43 or 44, wherein, to apply the semantic-aware style fusion to the aggregated training data to generate the fused training data, the at least one processor is configured to combine the common semantic region data and the background data to generate the fused training data.

Aspect 46. The apparatus of any of Aspects 25 to 45, wherein the at least one processor is configured to: combine class-specific semantic information extracted from the aggregated training data in an image space.

Aspect 47. The apparatus of any of Aspects 25 to 46, wherein the at least one processor is configured to: train the neural network using the updated training data.

Aspect 48. The apparatus of any of Aspects 25 to 47, wherein the at least one processor is configured to: train the neural network using a cross-entropy loss.

Aspect 49. A computer-readable storage medium storing instructions that, when executed by one or more processors, cause the one or more processors to perform operations according to any of Aspects 1 to 48.

Aspect 50. An apparatus for processing data, comprising one or more means for performing operations according to any of Aspects 1 to 48.

What is claimed is:

1. An apparatus for augmenting training data, comprising:
at least one memory; and
at least one processor coupled to at least one memory and configured to:
augment, via a random style generator having at least one randomly initialized layer, training data to generate augmented training data;
aggregate data with a plurality of styles from the augmented training data to generate aggregated training data;
apply semantic-aware style fusion to the aggregated training data to generate fused training data; and
add the fused training data as fictitious samples to the training data to generate updated training data for training a neural network.

2. The apparatus of claim 1, wherein the training data includes a plurality of training images.

3. The apparatus of claim 2, wherein a size of at least one kernel of the neural network is based on a size of an image of the plurality of training images.

4. The apparatus of claim 2, wherein the at least one processor is configured to:
augment texture data, contrast data, and brightness data of the plurality of training images.

5. The apparatus of claim 1, wherein, to augment the training data, the at least one processor is configured to randomly initialize a brightness parameter and a contrast parameter in an affine transformation layer of the random style generator.

6. The apparatus of claim 1, wherein, to augment the training data, the at least one processor is configured to perform deformable convolution, apply a random convolutional layer, and apply a deformable convolutional layer.

7. The apparatus of claim 1, wherein, to augment the training data, the at least one processor is configured to augment texture data in the training data using a randomly initialized deformable convolution layer.

8. The apparatus of claim 7, wherein one or more of weights and offsets are randomly initialized using the randomly initialized deformable convolution layer.

9. The apparatus of claim 8, wherein, to augment the training data, the at least one processor is configured to augment contrast data in the training data and brightness data in the training data using instance normalization, affine transformation, and a sigmoid function.

10. The apparatus of claim 9, wherein at least one parameter of the affine transformation is randomly initialized.

11. The apparatus of claim 1, wherein, to augment, via the random style generator, training data to generate augmented training data, the at least one processor is configured to randomly initialize at least one weight and at least one offset to achieve texture modification of the training data.

12. The apparatus of claim 1, wherein, to augment, via the random style generator, training data to generate augmented training data, the at least one processor is configured to preserve semantic data in the training data while distorting non-semantic data to increase data diversity.

13. The apparatus of claim 1, wherein the augmented training data comprises a randomly generated new style from the training data but maintains data semantics.

14. The apparatus of claim 1, wherein, to aggregate the data with the plurality of styles from the augmented training data to generate the aggregated training data, the at least one processor is configured to use random style aggregation in which the plurality of styles is selected randomly.

15. The apparatus of claim 1, wherein the at least one processor is configured to generate the plurality of styles by passing the augmented training data through the random style generator.

16. The apparatus of claim 1, wherein, to aggregate data with a plurality of styles from the augmented training data to generate the aggregated training data, the at least one processor is configured to pass a latest set of augmented training data through the random style generator.

17. The apparatus of claim 1, wherein, to apply the semantic-aware style fusion to the aggregated training data to generate the fused training data, the at least one processor is configured to apply the semantic-aware style fusion to the training data to generate the fused training data.

18. The apparatus of claim 1, wherein, to apply the semantic-aware style fusion to the aggregated training data to generate the fused training data, the at least one processor is configured to extract semantic regions from the training data and the augmented training data, wherein the semantic regions are used in the semantic-aware style fusion with the training data.

19. The apparatus of claim 18, wherein, to apply the semantic-aware style fusion to the aggregated training data to generate the fused training data, the at least one processor is configured to process a common semantic region with the training data and the augmented training data to generate common semantic region data.

20. The apparatus of claim 19, wherein, to apply the semantic-aware style fusion to the aggregated training data to generate the fused training data, the at least one processor is configured to process inverted data with the training data and the augmented training data to generate background data.

21. The apparatus of claim 20, wherein, to apply the semantic-aware style fusion to the aggregated training data to generate the fused training data, the at least one processor is configured to combine the common semantic region data and the background data to generate the fused training data.

22. The apparatus of claim 1, wherein the at least one processor is configured to:
combine class-specific semantic information extracted from the aggregated training data in an image space.

23. The apparatus of claim 1, wherein the at least one processor is configured to:
train the neural network using the updated training data.

24. The apparatus of claim 1, wherein the at least one processor is configured to:
train the neural network using a cross-entropy loss.

25. A processor-implemented method of augmenting training data, the method comprising:
augmenting, via a random style generator having at least one randomly initialized layer, training data to generate augmented training data;
aggregating data with a plurality of styles from the augmented training data to generate aggregated training data;
applying semantic-aware style fusion to the aggregated training data to generate fused training data; and
adding the fused training data as fictitious samples to the training data to generate updated training data for training a neural network.

26. The processor-implemented method of claim 25, wherein the training data includes a plurality of training images.

27. The processor-implemented method of claim 26, wherein a size of at least one kernel of the neural network is based on a size of an image of the plurality of training images.

28. The processor-implemented method of claim 26, wherein augmenting the training data comprises:
augmenting texture data, contrast data, and brightness data of the plurality of training images.

29. A computer-readable storage medium storing instructions that, when executed by one or more processors, cause the one or more processors to:
augment, via a random style generator having at least one randomly initialized layer, training data to generate augmented training data;
aggregate data with a plurality of styles from the augmented training data to generate aggregated training data;
apply semantic-aware style fusion to the aggregated training data to generate fused training data; and
add the fused training data as fictitious samples to the training data to generate updated training data for training a neural network.

30. An apparatus for processing data, comprising one or more:
means for augmenting, via a random style generator having at least one randomly initialized layer, training data to generate augmented training data;
means for aggregating data with a plurality of styles from the augmented training data to generate aggregated training data;
means for applying semantic-aware style fusion to the aggregated training data to generate fused training data; and
means for adding the fused training data as fictitious samples to the training data to generate updated training data for training a neural network.
